(19) United States
(12) Patent Application Publication
(10) Pub. No.: US 2008/0180360 A1
(43) Pub. Date: Jul. 31, 2008

(54) PLASMA DISPLAY DEVICE AND DRIVING METHOD THEREOF

(76) Inventor: Yoo-jin Song, Suwon-si (KR)

Correspondence Address: CHRISTIE, PARKER & HALE, LLP, PO BOX 7068, PASADENA, CA, 91109-7068, US

(21) Appl. No.: 11/969,138

(22) Filed: Jan. 3, 2008

(30) Foreign Application Priority Data
Jan. 25, 2007 (KR) 10-2007-0007975

(51) Int. Cl. G09G 3/28

(52) U.S. Cl. 345/60; 345/68; 315/169.4

(57) ABSTRACT

Disclosed are a plasma display device including a reset unit in an integrated circuit, which may prevent an erroneous operation and damage of the IC by sensing an input power source applied to the IC in order to control a reset or a non-reset of an operation of the IC, and a method for driving the same.

### CROSS-REFERENCE TO RELATED APPLICATIONS

This application claims priority to and the benefit of Korean Patent Application No. 10-2007-0007975, filed on Jan. 25, 2007, in the Korean Intellectual Property Office, the entire content of which is incorporated herein by reference.

### BACKGROUND

1. Field of the Invention

The present invention relates to a plasma display panel (referred to as ‘PDP’ hereinafter) device, and more particularly to a plasma display device including a reset unit in an integrated circuit (referred to as ‘IC’).

2. Discussion of Related Art

Recently, various flat panel displays such as liquid crystal displays (LCDs), field emission displays (FEDs), and plasma display panels (PDPs) have been actively developed. Among them, the PDP has higher luminance and emission efficiency, and wider viewing angle in comparison with other displays. Accordingly, the PDPs are in the spotlight as a display device larger than 40 inches as a substitute for cathode ray tubes (CRTs).

The PDP is a flat panel display, which displays characters or images by emitting light from a fluorescent material using plasma generated by a gas discharge. Pixels of several hundreds of thousands to millions are arranged in a matrix according to its size. The PDPs are classified into direct current (referred to as ‘DC’ hereinafter) and alternating current (referred to as ‘AC’ hereinafter) PDPs depending upon driving waveform shapes and discharge cell structures.

In a DC PDP, since the electrodes are exposed in a discharge space without insulation while a voltage is applied thereto, an electric current still flows in the discharge space. To accommodate this, a resistor for limiting the electric current should be provided. On the other hand, in an AC PDP, because a dielectric layer covers the electrodes, a capacitance component is naturally formed to limit an electric current. Since electrodes are protected from the shock of ions during a discharge, the AC PDP has a longer durable life than that of the DC PDP.

In the AC PDP, scan electrodes and sustain electrodes are formed on one surface in parallel with each other, and address electrodes is formed on another surface perpendicular to the scan electrodes and the sustain electrodes. The sustain electrodes are formed alternatingly with the scan electrodes, and are coupled in common at one terminal.

A method for driving the AC PDP is composed of a reset period, an addressing period, a sustain period, and an erase period according to a time operation change.

The reset period is a time period for initializing the state of each cell so that an addressing operation is easily performed in each cell. The address period is a time period to apply an address voltage for turning-on cells for storing wall charges so as to select turn-on cells and turn-off cells in a panel. The sustain period is a time period to perform a discharge for applying a sustain discharge voltage to actually display images on addressed cells. The erase period is a time period to reduce the wall charge of cells in order to finish a sustain discharge.

Furthermore, in order to provide a predetermined voltage to the scan electrode, the sustain electrode, and the address electrode, an IC is installed inside the PDP.

The ICs receive an operation power source and an input signal and provide a predetermined output voltage to the scan electrode, the sustain electrode, and the address electrode. Conventionally, when an operation voltage input to the IC in a floating state suddenly changes or a level of the input varies, the IC can be erroneously operated.

However, since an output signal is controlled inside the IC using a CLR signal or a latch enable signal, when the input signal of the operation power source unexpectedly changes, the IC cannot control it, and the changed input signal or operation power source is input thereto.

For example, when a level of a floating operation voltage less than a reference value is input thereto, the level of the signal applied to the IC is reduced. When a level of the power source or the input signal drops below a certain voltage, the level is input to the IC, and a control operation inside the IC becomes unstable causing erroneous operation of an internal switch of the IC. The erroneous operation of the internal switch may cause an erroneous operation and damage of the IC itself.

### SUMMARY OF THE INVENTION

Accordingly, one exemplary embodiment of the present invention is a plasma display device including a reset unit in an integrated circuit (referred to as ‘IC’), which may prevent a wrong operation and a damage of the IC by sensing an input power source applied to the IC in order to control a reset or a non-reset of an operation of the IC, and a method for driving the same.

The foregoing and/or other aspects of the present invention are achieved by providing a plasma display device including: a plasma display panel including a plurality of address electrodes, a plurality of scan electrodes, and a plurality of sustain electrodes, the address electrodes extending in a column direction and arranged in a row direction, and the scan and sustain electrodes extending in the row direction and arranged in the column direction; an address electrode driver for applying a display data signal to the address electrodes to select a discharge cell to be displayed; a sustain electrode driver and a scan electrode driver for applying a drive voltage to the sustain electrodes and the scan electrodes; a controller for receiving an image signal from an external source and for outputting an address drive control signal, a sustain electrode drive control signal, and a scan electrode drive control signal; a power supply for providing an input power to the address electrode driver, the scan electrode driver, and the sustain electrode driver; and reset units installed respectively at the address electrode driver, the sustain electrode driver, and the scan electrode driver, each of the reset units for sensing the input power applied to a corresponding one of the drivers to control a reset or a non-reset of the corresponding one of the drivers.

In some embodiments, at least one of the reset units receives the input power provided to the address electrode driver, the scan electrode driver, or the sustain electrode driver from the power supply, to output a first control signal and a second control signal, wherein the first control signal causes the corresponding one of the drivers to not be operated during a period in which the input power has a voltage less than or equal to a set voltage as determined by an internal comparator, and the second control signal causes the corresponding one of the drivers to be operated during a time period in which the input power has a voltage greater than the set voltage.

In some embodiments, the reset unit includes a comparator having a first input terminal and second input terminal; a Zener diode coupled between a first node and the second input terminal of the comparator, the input power being applied to the first node; and a transistor coupled between the first node and an output terminal of the reset unit for receiving an output of the comparator, wherein an input power having a voltage less than or equal to a set voltage is input to the first terminal of the comparator, and a voltage corresponding to a difference between the input power and a breakdown voltage of the Zener diode is input to the second terminal of the comparator.

In some embodiments, the reset unit further includes a first resistor coupled between the first input terminal of the comparator and the first node; and a second resistor coupled between the first input terminal of the comparator and a ground.

A voltage input to the first input terminal of the comparator is obtained by dividing the input power is divided by a first resistance of the first resistor and a second resistance of the second resistor, which is a voltage of (R2/(R1+R2))*Vdd, where R1 is the first resistance, R2 is the second resistance, and Vdd is the input power. A voltage input to the second terminal of the comparator is obtained by delaying the input power by a breakdown voltage of the Zener diode.

According to another aspect of the present invention, there is provided a method for driving a plasma display device including a plurality of address electrodes, extending in a column direction and arranged in a row direction, and a plurality of scan electrodes and a plurality of sustain electrodes extending in the row direction and sequentially arranged in a column direction, and for controlling a reset or a non-reset of drivers for driving the address electrodes, the scan electrodes and the sustain electrodes, the method including: comparing a second input voltage obtained by a difference between an input power and a breakdown voltage of a Zener diode applied to each of the drivers with a first input voltage applied to each of the drivers; outputting an output signal having a low level or a high level according to a result of the comparison; and outputting a first control signal or a second control signal for controlling an operation or a non-operation of the drivers according to the output signal.

In some embodiments, the first control signal is output to prevent operating the drivers during a period when the output signal has the low level. The input power is less than or equal to the set voltage during the time period when the output signal has the low level. The second control signal is output to operate the drivers during a period when the output signal has the high level. The input power source is greater than the set voltage during the period when the output signal has the high level. The second input voltage is delayed and input by the breakdown voltage of the Zener diode in comparison with the first input voltage. The second input voltage is compared with the first input voltage in each of the drivers.

According to another aspect of the present invention, there is a plasma display device including: a plasma display panel including a plurality of address electrodes, a plurality of scan electrodes, a plurality of sustain electrodes, and a plurality of discharge cells, the address electrodes extending in a column direction, the scan and sustain electrodes extending in the row direction; an address electrode driver for applying a display data signal to the address electrodes to select one or more of the discharge cells to be displayed, the address electrode driver comprising a first reset unit; a sustain electrode driver and a scan electrode driver for respectively applying a drive voltage to the sustain electrodes and the scan electrodes, the sustain electrode driver comprising a second reset unit and the scan electrode deriver comprising a third reset unit; a controller for receiving an image signal from an external source and for outputting an address drive control signal, a sustain electrode drive control signal, and a scan electrode drive control signal; and a power supply for providing an input power to the address electrode driver, the scan electrode driver, and the sustain electrode driver, wherein each of the reset units is adapted to sense the input power to determine whether to operate or not operate a corresponding one of the drivers according to a voltage level of the input power.

In some embodiments, the corresponding one of the drivers is not operated when the voltage level of the input power is lower than a set voltage. The drivers are implemented in an integrated circuit (IC) chip.

### BRIEF DESCRIPTION OF THE DRAWINGS

These and/or other aspects and features of the invention will become apparent and more readily appreciated from the following description of the embodiments, taken in conjunction with the accompanying drawings of which:

FIG. 1 is a block diagram showing a plasma display device according to an embodiment of the present invention;

FIG. 2 is a circuit diagram of a reset unit, which is installed inside an IC according to an embodiment of the present invention; and

FIG. 3 is a timing chart showing an operation of the reset unit shown in FIG. 2.

### DETAILED DESCRIPTION

Hereinafter, exemplary embodiments according to the present invention will be described with reference to the accompanying drawings. Here, when one element is referred to as being coupled to a second element, one element may be not only directly coupled to the second element but instead may be indirectly coupled to the second element via another element. Further, some elements not necessary for a complete description are omitted for clarity. Also, like reference numerals refer to like elements throughout.

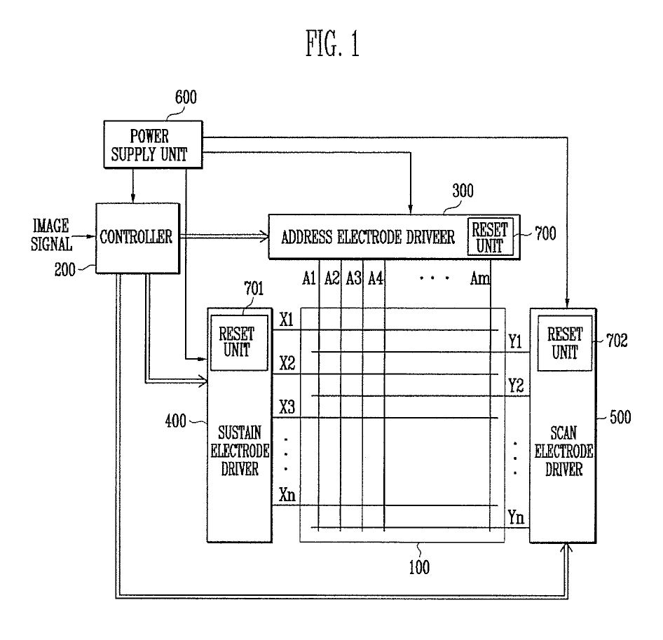

FIG. 1 is a block diagram showing a plasma display device according to an embodiment of the present invention.

As shown in FIG. 1, the plasma display device according to an embodiment of the present invention includes a plasma display panel 100, a controller 200, an address electrode driver 300, a sustain electrode driver 400, a scan electrode driver 500, a power supply unit 600, and reset units 700, 701, and 702. The reset unit is installed inside each of the address electrode driver 300, the sustain electrode driver 400, and the scan electrode driver 500 and senses an input power source Vdd applied thereto to control a reset or a non-reset of an operation (e.g., operation or non-operation) of each of the drivers. In one embodiment, the address electrode driver 300, the sustain electrode driver 400, and the scan electrode driver 500 are implemented by using an integrated circuit (IC).

By way of example, an embodiment of the present invention is characterized in that the reset unit 700, 701 or 702 is installed inside an IC and senses an input power source Vdd applied to the IC to provide a reset function of the IC.

The plasma display panel 100 includes a plurality of address electrodes A1 to Am, a plurality of sustain electrodes X1 to Xn, and a plurality of scan electrodes Y1 to Yn. The plurality of address electrodes A1 to Am extend in a column direction and are arranged in a row direction. The plurality of sustain electrodes X1 to Xn and the plurality of scan electrodes Y1 to Yn extend in a row direction and are arranged in a column direction in pairs. The sustain electrodes X1 to Xn are formed corresponding to respective scan electrodes Y1 to Yn, and the sustain electrodes X1 to Xn are coupled in common at one terminal.

Further, the plasma display panel 100 includes a first substrate (not shown) and a second substrate (not shown). The sustain electrodes X1 to Xn and the scan electrodes Y1 to Yn are arranged on the first substrate. The address electrodes A1 to An are arranged on the second substrate. The first substrate and the second substrate are oppositely arranged with discharge spaces therebetween. The scan electrodes Y1 to Yn are formed perpendicular to the address electrode A1 to Am, and the sustain electrodes X1 to Xn are formed perpendicular to the address electrodes A1 to Am. Here, the discharge spaces formed at crossing areas of the address electrodes A1 to Am, the sustain electrodes X1 to Xn, and the scan electrodes Y1 to Yn define discharge cells. The structure of plasma display panel 100 is one example. A panel having another structure to which drive waveforms are applied is applicable to the present invention, which will be described later.

The controller 200 receives an image signal from an exterior source and outputs an address drive control signal, a sustain electrode X drive control signal, and a scan electrode Y drive control signal. The controller 200 divides one frame into a plurality of subfields to drive them. Each of the subfields includes a reset period, an address period, and a sustain period according to a time operation change.

The address electrode driver 300 receives the address drive control signal from the controller 200 and applies a display data signal for selecting discharge cells to be displayed to each address electrode.

The sustain electrode driver 400 receives the sustain electrode X drive control signal and applies a drive voltage to the sustain electrode X.

The scan electrode driver 500 receives the scan electrode Y drive control signal from the controller 200 and applies a drive voltage to the scan electrode Y.

The power supply unit 600 supplies a power source necessary to drive the plasma display device to the controller 200 and the respective drivers 300, 400, and 500.

Here, the address electrode driver 300, the sustain electrode driver 400, and the scan electrode driver 500 are implemented by using an IC, which is installed inside the plasma display device.

Furthermore, the ICs receive an input power source Vdd from the power supply unit 600, receive a control signal and an input signal from the controller 200, and provide a predetermined drive voltage to the scan electrode, the sustain electrode, and the address electrode.

In conventional plasma display devices, when an input power source input to the IC in a floating state suddenly changes or a level of the input varies, the IC can be erroneously operated. However, since an output signal is controlled using a CLR signal or a latch enable signal inside the IC, when an unexpected variation occurs in the input signal or the input power source, it cannot be controlled and the varied value is input to the IC.

In an exemplary embodiment of the present invention, the address electrode driver 300, the sustain electrode driver 400, and the scan electrode driver 500 of the IC respectively include reset units 700, 701, and 702. The reset units 700, 701, and 702 may have substantially the same structures and functions from each other.

The reset units 700, 701, and 702 respectively sense an input power source Vdd applied to the address electrode driver 300, the sustain electrode driver 400, and the scan electrode driver 500. When the input power source Vdd is within a certain range, namely, a range for normal IC performance, the reset units 700, 701, and 702 respectively apply a reset signal to the drivers.

By way of example, the reset units 700, 701, and 702 respectively receive the input power source Vdd applied to respective ICs, namely the address electrode driver 300, the sustain electrode driver 400, and the scan electrode driver 500, from the power supply unit 600, and respectively output a first control signal and a second control signal. The first control signal causes the drivers, including the reset unit 700, 701, or 702, not to be driven during a period in which the input power source Vdd is less than or equal to a set voltage as determined by an internal comparator. The second control signal causes the drivers, including the reset unit 700, 701, or 702, to be operated during a time period in which the input power source Vdd is greater than the set voltage.

For example, the reset unit 700 included in the address electrode driver 300 senses the input power source Vdd input to the address electrode driver 300. The reset unit 700 generates and provides the first control signal during a time period in which the input power source that is less than the set voltage is applied to the address electrode driver 300, so that the address electrode driver 300 does not operate. In contrast to this, the reset unit 700 generates and provides the second control signal during a time period in which the input power source that is equal to or greater than the set voltage is applied to the address electrode driver 300, so that the address electrode driver 300 operates normally.

Although an operation of the reset unit 700 of the address electrode driver 300 is described above, the same operation is performed in the reset units 701 and 702, respectively, of the sustain electrode driver 400 and the scan electrode driver 500.

The aforementioned operations can reduce or prevent an erroneous operation while the input signal and the input power source applied to the IC are in an unstable state, and damage of the IC due to the erroneous operation. This allows the defective rate of the final product to be reduced, and the reliability of the device and the manufacturing yield to be enhanced.

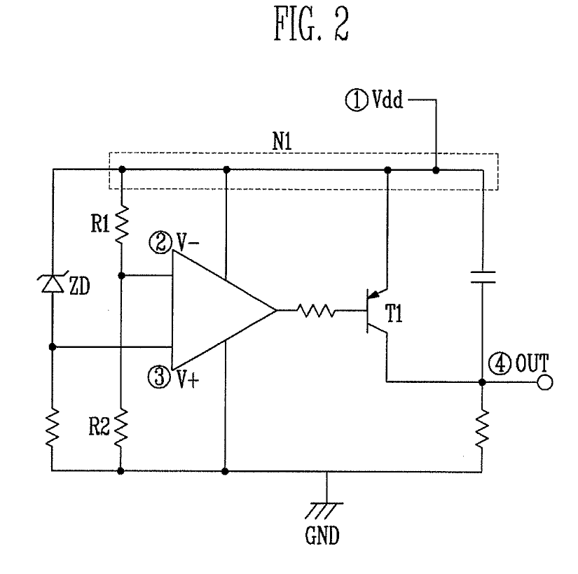

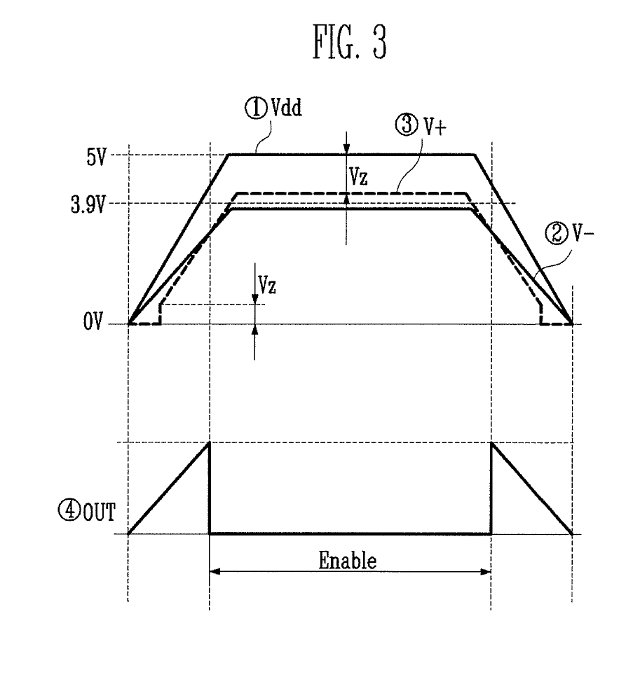

FIG. 2 is a circuit diagram of a reset unit, which is installed inside an IC according to an embodiment of the present invention. FIG. 3 is a timing chart showing the operation of the reset unit shown in FIG. 2.

As described above, the reset unit 700, 701, or 702 is included in each of the drivers.

Referring to FIG. 2, the reset unit 700, 701, or 702 includes a comparator having first and second input terminals V− and V+; a first resistor R1 coupled between the first input terminal V− of the comparator and the first node N1 to which the input power source is applied; and a second resistor R2 coupled between the first input terminal V− of the comparator and a ground; a Zener diode ZD coupled between a first node N1 and the second input terminal V+ of the comparator, the input power source Vdd being applied to the first node N1; and a transistor T1 coupled between the first node N1 and an output terminal OUT of the reset unit for receiving an output of the comparator.

Here, the comparator compares an amplitude of a second voltage input to the second input terminal V+ with an amplitude of a first voltage input to the first input terminal V−. When the amplitude of the first voltage is greater than the amplitude of the second voltage, the comparator outputs a low level signal. In contrast to this, when the amplitude of the first voltage is less than or equal to the amplitude of the second voltage, the comparator outputs a high level signal. In other words, the first input terminal V− functions as an inverting input terminal, whereas the second input terminal V+ functions as a non-inverting input terminal.

In the described embodiment of the present invention, the input power source Vdd having a value less than a voltage set by a user is input to the first input terminal V−. The input power source Vdd is delayed by a breakdown voltage Vz of a Zener diode and the delayed power source is input to the second input terminal V+. That is, a voltage corresponding to a difference (Vdd−Vz) between the input power source Vdd and the breakdown voltage Vz is input to the second input terminal V+.

Further, the transistor T1 functions as a switch. An embodiment of the present invention has been described in which the transistor T1 is a PNP type BJT. This is one example, and the present invention is not limited thereto.

Accordingly, the base of the transistor T1 receives an output signal of the comparator. The transistor T1 is turned-on/off according to a voltage level of the output signal of the comparator. When the transistor T1 is turned-on, an emitter of the transistor T1 coupled to the first node N1 and a collector of the transistor T1 coupled to the output terminal OUT are electrically conducting to allow a current to flow.

Further, an input power source Vdd from the power supply unit 600 is applied to the first node N1.

Accordingly, in the case of the embodiment shown in FIG. 2, a voltage input to the first input terminal V−\textcircled{2} of the comparator is obtained by dividing the input power source Vdd \textcircled{1} by the resistance of the first resistor R1 and the resistance of the second resistor R2, which is a voltage of (R2/(R1+R2))*Vdd. When the input power source Vdd has a value greater than a breakdown voltage Vz of the Zener diode, a voltage of Vdd−Vz is applied to the second input terminal V+\textcircled{3} of the comparator.

As illustrated earlier, when the voltages are applied to the first input terminal V− and the second input terminal V+ of the comparator, the comparator compares the voltage applied to the second input terminal V+ with the voltage applied to the first input terminal V−, and outputs a low or high level signal according to the comparison result.

Here, when the output of the comparator has a low level, the output signal of the low level is input to a base of the transistor T1 to turn-on the transistor T1. Accordingly, the input power source Vdd applied to the first node coupled to the emitter of the transistor T1 is output through an output terminal OUT \textcircled{4}, which is coupled to the collector thereof.

In contrast, when the output of the comparator has a high level, the output signal of the high level is input to the base of the transistor T1 to turn-off the transistor T1. Accordingly, a low level voltage corresponding to a ground voltage is output through an output terminal OUT, which is coupled to the collector thereof.

In the described embodiment of the present invention, the low level voltage of the signals output through the output terminal is used as an enable signal to normally operate the respective drivers including the reset unit.

That is, the reset unit 700, 701, and 702, respectively receive the input power source provided to the address electrode driver 300, the scan electrode driver 500, and the sustain electrode driver 400 from the power supply unit 600, and each output a first control signal and a second control signal. Here, the first control signal causes the drivers, including the reset unit, not to be driven during a period in which the input power source is less than or equal to a set voltage, as determined by an internal comparator, and the second control signal causes the drivers including the reset unit to be operated during a period in which the input power source is greater than the set voltage.

Hereinafter, a detailed operation of the reset unit according to an embodiment of the present invention will be described with reference to FIG. 2 and FIG. 3.

For the convenience of description, it is assumed that an operation voltage Vcc is 5V, and a set voltage is 3.9V. Those skilled in the art would recognize, however, that the voltages Vcc and the set voltage could have other suitable voltages.

Here, the operation voltage Vcc is a voltage applied in order to normally operate respective drivers, and is supplied by the input power source provided from the power supply unit 600. The input power source Vdd has a voltage identical to the operation voltage Vcc, which is 5 V, except during a rising time period and a falling time period. Here, the rising time period and the falling time period correspond to time periods in which the input voltage is initially and finally applied from the power supply unit 600, respectively.

However, during the rising time period and the falling time period, when the drivers operate, an erroneous operation mentioned above can occur. Accordingly, in an embodiment of the present invention, so as to solve this problem, the drivers can operate only when an input power source having a voltage greater than the set voltage is applied.

With reference to FIG. 3, as explained earlier, the input power source Vdd includes rising and falling time periods (e.g., predetermined rising and falling time periods). During remaining time periods, the input power source Vdd maintains 5V.

Furthermore, the voltage input to the first input terminal V− increases or decreases as the input voltage Vdd increases or decreases corresponding to the equation (R2/(R1+R2))*Vdd. In one embodiment, the resistors R1 and R2 are selected such that the voltage at the input voltage V− reaches a desired voltage when the input voltage Vdd reaches the preset voltage (e.g. 3.9 V).

In addition, the voltage input to the second input terminal V+ from the input power source Vdd is delayed by a breakdown voltage Vz of the Zener diode ZD, and a voltage corresponding to a difference (Vdd−Vz) between the input power source Vdd and the breakdown voltage Vz is applied to the second input terminal V+.

As mentioned above, when respective voltages are applied to the first input terminal V− and the second input terminal V+ of the comparator, the comparator compares the voltages input to the first and second input terminals V− and V+, and outputs a low level or high level signal according to the comparison result.

That is, the comparator compares an amplitude of a second voltage input to the second input terminal V+ with an amplitude of a first voltage input to the first input terminal V−. When the amplitude of the first voltage is greater than the amplitude of the second voltage, the comparator outputs a low level signal. In contrast, when the amplitude of the first voltage is less than or equal to the amplitude of the second voltage, the comparator outputs a high level signal.

As shown in FIG. 3, during a time period in which the set voltage is input to the first input terminal V− and the voltage input to the second input terminal V+ is greater than the voltage input to the first input terminal V−, the comparator outputs a high level signal. During the remaining periods, because the voltage input to the first input terminal V− is greater than or equal to the voltage input to the second input terminal V+, the comparator outputs a low level signal.

In other words, when the input power source Vdd having a voltage less than or equal to the set voltage is applied, the comparator outputs the low level signal. In contrast, when the input power source Vdd having a voltage greater than the set voltage is applied, the comparator outputs the high level signal.

Here, when an output of the comparator has a low level, the low level output signal is input to the base of the transistor T1 to turn-on the transistor T1. Accordingly, the input power source Vdd applied to the first node coupled to the emitter of the transistor T1 is output through an output terminal OUT, which is coupled to the collector thereof.

That is, as shown in FIG. 3, during a time period when the output of the comparator has a low level, namely, the input power source Vdd having a voltage less than or equal to the set voltage is applied, the input power source Vdd is output through a final output terminal OUT of the reset unit 700, 701, or 702. Here, the input power source functions as a first control signal so that a driver including the reset unit 700, 701, or 702, does not operate.

In contrast, when the output of the comparator has a high level, the high level output signal is input to the base of the transistor T1 to turn-off the transistor T1. Accordingly, a low level voltage corresponding to a ground voltage is output through an output terminal OUT, which is coupled to the collector thereof.

As shown in FIG. 3, during a time period when the output of the comparator has a high level, namely, the input power source Vdd having a voltage greater than the set voltage is applied, the low level voltage is output through a final output terminal OUT of the reset unit 700, 701, or 702. Here, the low level voltage functions as a second control signal so that a driver including the reset unit 700, 701, or 702, operates.

As a result, the reset unit 700, 701, or 702, receives the input power source Vdd provided to respective drivers including the reset unit 700, 701, or 702, from the power supply unit 600, and outputs a first control signal and a second control signal. The first control signal causes the drivers including the reset unit 700, 701, or 702, not to be driven during a period in which the voltage of the input power source is less than or equal to a set voltage as determined by an internal comparator. The second control signal causes the drivers including the reset unit 700, 701, or 702, to be operated during a period in which the voltage of the input power source is greater than the set voltage.

The aforementioned operations can prevent or reduce an erroneous operation when an unstable input signal and input power source are applied to the IC, and damage of the IC due to the erroneous operation. This causes the defective rate of the final product to be reduced, and the reliability of the device and the manufacturing yield to be enhanced.

Although a few exemplary embodiments of the present invention have been shown and described, it would be appreciated by those skilled in the art that changes might be made to these embodiments without departing from the principles and spirit of the invention, the scope of which is defined in the claims and their equivalents.

What is claimed is:

1. A plasma display device comprising:
a plasma display panel including a plurality of address electrodes, a plurality of scan electrodes, and a plurality of sustain electrodes, the address electrodes extending in a column direction, and the scan and sustain electrodes extending in the row direction;
an address electrode driver for applying a display data signal to the address electrodes to select a discharge cell to be displayed;
a sustain electrode driver and a scan electrode driver for respectively applying a drive voltage to the sustain electrodes and the scan electrodes;
a controller for receiving an image signal from an external source and for outputting an address drive control signal, a sustain electrode drive control signal, and a scan electrode drive control signal;
a power supply for providing an input power to the address electrode driver, the scan electrode driver, and the sustain electrode driver; and
reset units installed respectively at the address electrode driver, the sustain electrode driver, and the scan electrode driver, each of the reset units for sensing the input power applied to a corresponding one of the drivers to control a reset or a non-reset of the corresponding one of the drivers.

2. The plasma display device as claimed in claim 1, wherein at least one of the reset units receives the input power provided to the address electrode driver, the scan electrode driver, or the sustain electrode driver from the power supply, to output a first control signal and a second control signal, wherein the first control signal causes the corresponding one of the drivers to not be operated during a period in which the input power has a voltage less than or equal to a set voltage as determined by an internal comparator, and
wherein the second control signal causes the corresponding one of the drivers to be operated during a time period in which the input power has a voltage greater than the set voltage.

3. The plasma display device as claimed in claim 1, wherein at least one of the reset units includes:
a comparator having a first input terminal and a second input terminal;
a Zener diode coupled between a first node and the second input terminal of the comparator, the input power being applied to the first node; and
a transistor coupled between the first node and an output terminal of the at least one of the reset units for receiving an output of the comparator,
wherein the input power having a voltage less than or equal to a set voltage is input to the first terminal of the comparator, and a voltage corresponding to a difference between the input power and a breakdown voltage of the Zener diode is input to the second terminal of the comparator.

4. The plasma display device as claimed in claim 3, wherein the at least one of the reset units further comprises:
a first resistor coupled between the first input terminal of the comparator and the first node; and
a second resistor coupled between the first input terminal of the comparator and a ground.

5. The plasma display device as claimed in claim 4, wherein a voltage input to the first input terminal of the comparator is obtained by dividing the input power by a first resistance of the first resistor and a second resistance of the second resistor, which is a voltage of (R2/(R1+R2))*Vdd, where R1 is the first resistance, R2 is the second resistance, and Vdd is the input power.

6. The plasma display device as claimed in claim 4, wherein a voltage input to the second terminal of the comparator is obtained by delaying the input power source by a breakdown voltage of the Zener diode.

7. A method for driving a plasma display device including a plurality of address electrodes, extending in a column direction and arranged in a row direction, and a plurality of scan electrodes and a plurality of sustain electrodes, extending in the row direction and arranged in the column direction, and for controlling a reset or a non-reset of drivers for driving the address electrodes, the scan electrodes, and the sustain electrodes, the method comprising:
comparing a second input voltage obtained as a difference between a voltage of an input power and a breakdown voltage of a Zener diode with a first input voltage that is less than or equal to a set voltage;
outputting an output signal having a low level or a high level according to a result of the comparison; and
outputting a first control signal or a second control signal for controlling an operation or a non-operation of the drivers according to the output signal.

8. The method as claimed in claim 7, wherein the first control signal is output to prevent operating a corresponding one of the drivers during a time period when the output signal has the low level.

9. The method as claimed in claim 8, wherein the voltage of the input power is less than or equal to the set voltage during the time period when the output signal has the low level.

10. The method as claimed in claim 7, wherein the second control signal is output to operate the drivers during a time period when the output signal has the high level.

11. The method as claimed in claim 10, wherein the input power source is greater than the set voltage during the time period when the output signal has the high level.

12. The method as claimed in claim 7, wherein the second input voltage is delayed by the breakdown voltage of the Zener diode in comparison with the first input voltage.

13. The method as claimed in claim 7, wherein the second input voltage is compared with the first input voltage in each of the drivers.

14. A plasma display device comprising:
a plasma display panel including a plurality of address electrodes, a plurality of scan electrodes, a plurality of sustain electrodes, and a plurality of discharge cells, the address electrodes extending in a column direction, the scan and sustain electrodes extending in the row direction;
an address electrode driver for applying a display data signal to the address electrodes to select one or more of the discharge cells to be displayed, the address electrode driver comprising a first reset unit;
a sustain electrode driver and a scan electrode driver for respectively applying a drive voltage to the sustain electrodes and the scan electrodes, the sustain electrode driver comprising a second reset unit and the scan electrode deriver comprising a third reset unit;
a controller for receiving an image signal from an external source and for outputting an address drive control signal, a sustain electrode drive control signal, and a scan electrode drive control signal; and
a power supply for providing an input power to the address electrode driver, the scan electrode driver, and the sustain electrode driver,
wherein each of the reset units is adapted to sense the input power to determine whether to operate or not operate a corresponding one of the drivers according to a voltage level of the input power.

15. The plasma display device of claim 14, wherein the corresponding one of the drivers is not operated when the voltage level of the input power is lower than a set voltage.

16. The plasma display device of claim 14, wherein each of the drivers are implemented in an integrated circuit (IC) chip.
